(19) United States
(12) Patent Application Publication
(10) Pub. No.: US 2009/0072772 A1
(43) Pub. Date: Mar. 19, 2009

(54) DIESEL-ELECTRIC DRIVE SYSTEM HAVING A SYNCHRONOUS GENERATOR WITH PERMANENT MAGNET EXCITATION

(75) Inventors: Andreas Fuchs, Erlangen (DE); Olaf Korner, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/282,002

(22) PCT Filed: Jan. 25, 2007
(86) PCT No.: PCT/EP07/50729

§ 371 Date: Sep. 8, 2008

(30) Foreign Application Priority Data
Mar. 7, 2006 (DE) 102006010537.0

(51) Int. Cl. H02P 3/22

(52) U.S. Cl. 318/375

(57) ABSTRACT

The invention relates to a diesel-electric drive system comprising a permanently excited synchronous generator (4), which is mechanically coupled to a diesel motor (2) on the rotor side and has an electrical connection to a voltage link converter (6) on the stator side, said converter having a respective self-commutated pulse-controlled converter (12, 14) on the generator and load sides. The converters are interconnected on the d.c. voltage side by means of a d.c. link (18). The system also comprises a braking resistor (20), which can be electrically connected to said d.c. link (18). According to the invention, a multi-phase braking resistor assembly, which can be electrically connected in series to the multi-phase stator winding system (74) of the permanently excited synchronous generator (4) by means of a multi-phase actuator (32), is provided as the braking resistance. This permits the provision of a diesel-electric drive system which no longer requires an additional brake attenuator and in which the mode can be changed between generator mode and operating mode, the speed of said diesel motor being freely set in the operating mode.

The invention relates to a diesel-electric drive system as claimed in the precharacterizing clause of claim 1.

A drive system of this generic type is disclosed in the publication entitled “Energy Efficient Drive System for a Diesel Electric Shunting Locomotive”, by Olaf Koerner, Jens Brand and Karsten Rechenberg, printed in the Conference Proceedings “EPE' 2005”, of the EPE Conference in Dresden on Sep. 11 to 14, 2005. This publication compares two diesel-electric drive systems having a synchronous generator with permanent magnet excitation. These two drive systems differ only in that the converter on the generator side of the voltage intermediate-circuit converter is in one case a diode rectifier, and in the other case a self-commutated pulse-control converter. The self-commutated pulse-control converter is referred to in this publication as an IGBT rectifier. In both drive systems, a braking resistance can be connected to the intermediate circuit of the voltage intermediate-circuit converter. A thyristor which can be turned off is provided for this purpose, and is also referred to as a gate turn off thyristor (GTO thyristor). This pulse-controlled resistance is used to ensure that the DC voltage in the intermediate circuit of the voltage intermediate-circuit converter does not exceed a maximum permissible intermediate-circuit voltage in the braking mode, that is to say when the load, in particular a rotating field machine, supplies power to the intermediate circuit. A portion of this braking power is used to compensate for the drag torque of the idling diesel engine. One disadvantage is that a further converter bridge arm must be used for the braking controller, and this braking controller must additionally be connected to the intermediate circuit rail system. In this case, care must be taken to ensure that the braking controller is connected with a low inductance. Depending on the braking torque, it may be necessary to use further converter bridge arms for the braking controller, connected electrically in parallel. Furthermore, a control apparatus is required for the gate turn off thyristor. In addition, the gate turn off thyristor which is used as a braking controller has a complex circuitry network which requires a corresponding amount of space.

DE 102 10 164 A1 discloses an apparatus for multiple rectifier feeding of a synchronous motor with permanent magnet excitation in a power station. This synchronous generator with permanent magnet excitation has two polyphase stator winding systems, with different numbers of turns. The first winding system is connected to a controlled rectifier, for example to an IGBT rectifier. This controlled rectifier has the task of regulating the power output and therefore the rotation speed of the synchronous generator with permanent magnet excitation. For this purpose, current flows in the low rotation speed range and, in consequence, the electrical power flows exclusively via this winding system and therefore via the controlled rectifier which is connected to a DC voltage intermediate circuit. The second winding system is connected to an uncontrolled rectifier, for example a multipulse diode bridge, which is likewise connected to the same DC voltage intermediate circuit as the controlled rectifier. If the phase-to-phase rotation voltage (also referred to as the rotor voltage) is greater than the intermediate-circuit voltage of the DC voltage intermediate circuit, a current can flow in the second winding system and is rectified via the uncontrolled rectifier to the DC voltage intermediate circuit. In this case, the amplitude and phase angle of the current in the second winding system can be influenced by the current in the first winding system, which is regulated by the active rectifier (controlled rectifier), by means of the magnetic coupling between the first and the second winding system. This means that the controlled rectifier can also to a certain extent regulate the current in the winding system of the uncontrolled rectifier. The power transmitted from this apparatus is passed mainly to the uncontrolled rectifier in order to allow the controlled rectifier to be designed for low power, and therefore cost little. This controlled rectifier, which is generally also referred to as a self-commutated pulse-control converter, avoids highly overexcited operation of the synchronous generator with permanent magnet excitation. Furthermore, this compensates for harmonics in the generator torque caused by the uncontrolled rectifier.

The invention is now based on the object of improving the diesel-electric drive system of this generic type such that it is possible to dispense with an additional braking controller.

According to the invention, this object is achieved by the characterizing features of claim 1 in conjunction with the features of its precharacterizing clause.

Since the braking resistance provided is a polyphase braking resistance arrangement which can be connected by means of a polyphase switching apparatus electrically in series with the polyphase stator winding system of the synchronous generator with permanent magnet excitation, there is no longer any need for an additional braking controller. The braking current is controlled by means of the self-commutated pulse-control converter on the generator side of the voltage intermediate-circuit converter. If the polyphase braking resistance arrangement is connected electrically in series with the polyphase stator winding system of the synchronous generator with permanent magnet excitation by means of the polyphase switching apparatus, for braking purposes, then this synchronous generator is operated virtually short-circuited at the maximum braking power (maximum braking current). If the series inductance is sufficient, the continuous short-circuit current will only slightly exceed the rated current of this synchronous generator with permanent magnet excitation. This continuous short-circuit current flows through the series-connected braking resistances in the polyphase braking resistance arrangement, thus dissipating the required braking power. The virtually entirely short-circuited synchronous generator with permanent magnet excitation when in the braking mode results in a generated converter input voltage for the self-commutated pulse-control converter on the generator side of the voltage intermediate-circuit converter at the terminals of the polyphase braking resistance arrangement, in order to drive the braking current.

Since the short-circuit current of the synchronous generator with permanent magnet excitation is approximately constant between the idling speed and the rated rotation speed of the diesel engine, the diesel engine rotation speed may be chosen freely in the braking mode. The iron losses in the synchronous generator with permanent magnet excitation when in the braking mode are very low because of the field-attenuating short-circuit current. The drag losses, which correspond to the rotation speed of the diesel engine, can be compensated for by the synchronous generator with permanent magnet excitation by means of a small, positive, torque-forming current component of the converter motor. The diesel engine can therefore run without fuel injection during electrical braking.

Dependent claims 2 to 5 disclose how the braking resistances in the polyphase braking resistance arrangement can be connected electrically in series with windings of the polyphase stator winding system of the synchronous generator with permanent magnet excitation.

In a first embodiment, one braking resistance in the polyphase braking resistance arrangement is connected in series with one winding of the polyphase stator winding system by the synchronous generator with permanent magnet excitation having no star point. In the generator mode, the star point is produced by two disconnectors, through which no current passes when the voltage intermediate-circuit converter is blocked. This could also occur at the rated rotation speed of the diesel engine since the synchronous generator with permanent magnet excitation is operated with inadequate excitation and the diesel generator cannot feed into the intermediate circuit via the freewheeling diodes in the self-commutated pulse-control converter on the generator side of the blocked voltage intermediate-circuit converter, even at full rotation speed. A change can therefore be made from the maximum diesel generator power at the rated rotation speed to the braking mode without the diesel engine having to idle.

As a result of the disconnection of the star point, when the synchronous generator with permanent magnet excitation is short-circuited, virtually the entire converter input voltage of the voltage intermediate-circuit converter is then applied to the resistance terminals of the resistances in the polyphase braking resistance arrangement. In order to allow a polyphase switching apparatus to connect braking resistances in a braking resistance arrangement electrically in series with windings of a polyphase stator winding system of a synchronous generator with permanent magnet excitation, the winding ends of each winding of the polyphase stator winding system must be passed out of the synchronous generator with permanent magnet excitation. The star point of the synchronous generator with permanent magnet excitation is therefore connected outside the generator.

In a further embodiment of the series connection of a polyphase braking resistance arrangement to a polyphase stator winding system of a synchronous generator with permanent magnet excitation, this braking resistance arrangement has at least one braking resistance which can be bridged by means of a short-circuiter. This braking resistance arrangement may also have two resistances which can each be bridged by one short-circuiter. If the braking resistance arrangement has three resistances, then these can each likewise be bridged by means of one short-circuiter. This means that, in further embodiments, the braking resistance arrangements are designed for one, two or three phases. Each braking resistance in each braking resistance arrangement is connected electrically in series with one winding of the polyphase stator winding system of the synchronous generator with permanent magnet excitation. In the braking mode, each short-circuiter is open. In these further embodiments, there is no longer any need to pass both winding ends of each winding of the polyphase stator winding system of the synchronous generator with permanent magnet excitation out of this generator. As a consequence, the star point of the polyphase stator winding system is connected internally. There is therefore no longer any need for a special type of synchronous generator with permanent magnet excitation.

In a further advantageous embodiment, the braking resistances in the polyphase braking resistance arrangement which are connected electrically in series with one winding of the polyphase stator winding system can be short-circuited by means of a polyphase circuit breaker. This polyphase circuit breaker therefore carries out a protective function for the self-commutated pulse-control converter on the generator side of the voltage intermediate-circuit converter in all operating modes of the diesel-electric drive system.

In order to explain the invention further, reference is made to the drawing, which schematically illustrates a plurality of exemplary embodiments of a diesel-electric drive system according to the invention, and in which:

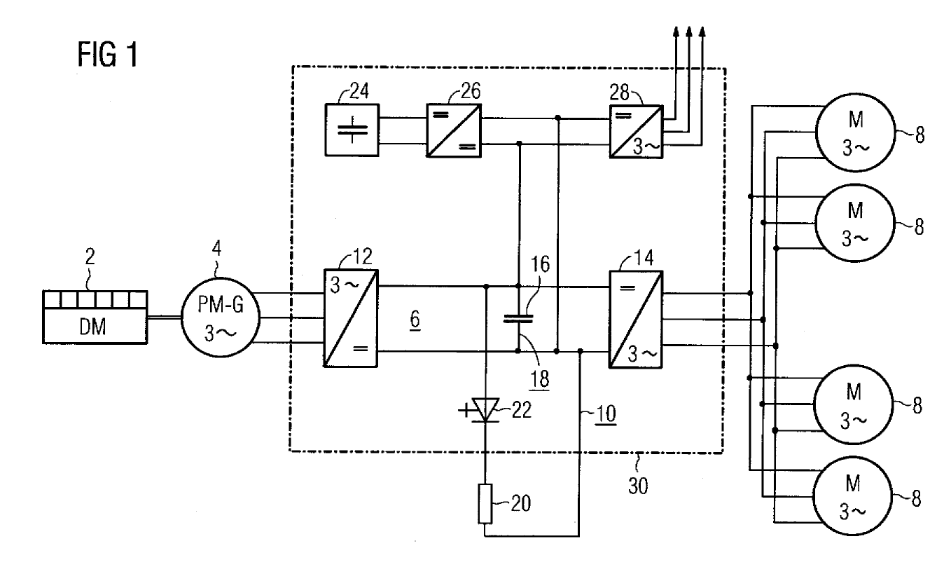

FIG. 1 shows an equivalent circuit of a diesel-electric drive system of this generic type,

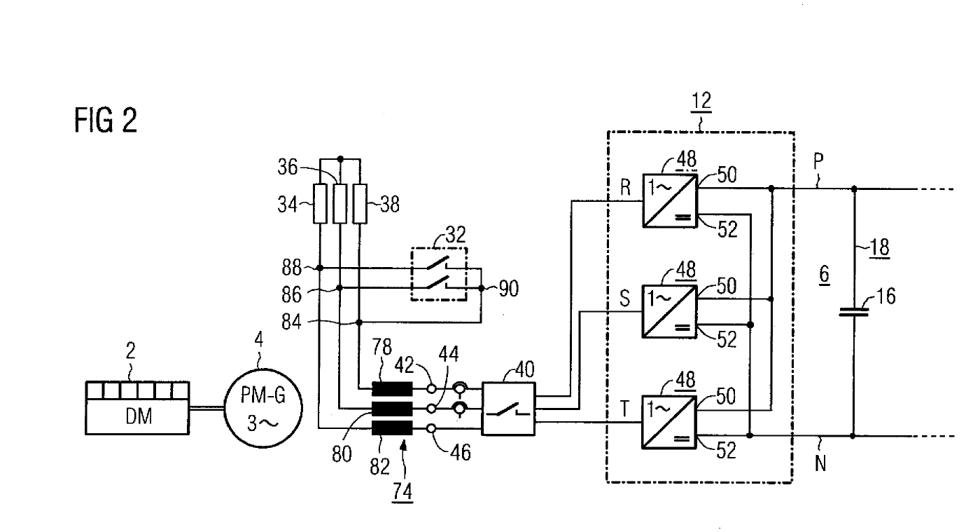

FIG. 2 shows an equivalent circuit of a first embodiment of a diesel-electric drive system according to the invention,

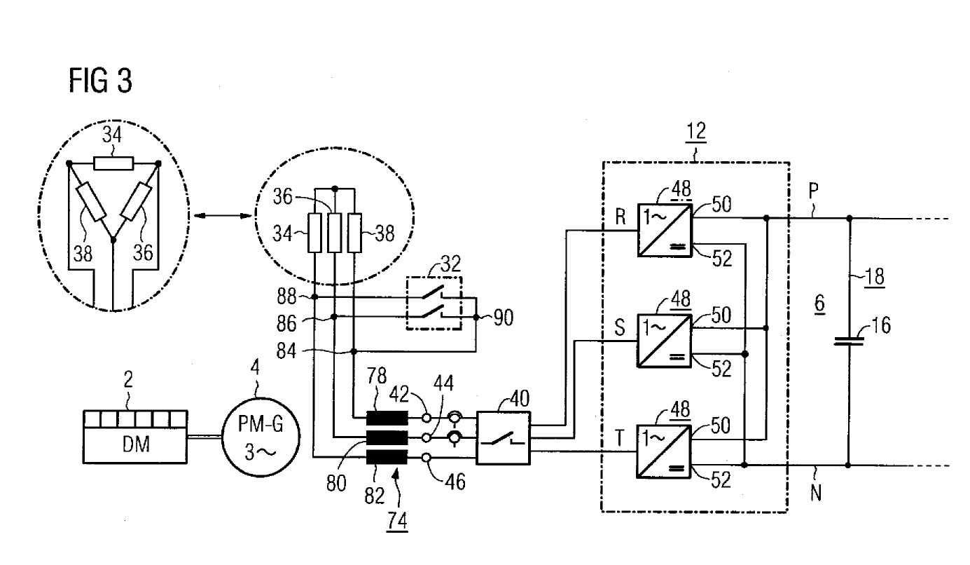

FIG. 3 shows an equivalent circuit of one variant of the first embodiment of the diesel-electric drive system according to the invention as shown in FIG. 1,

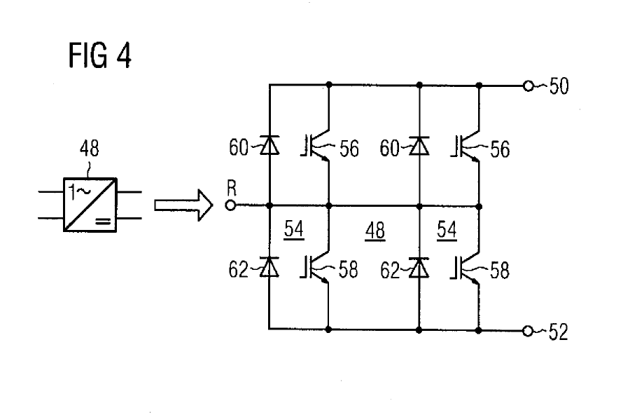

FIG. 4 shows an equivalent circuit of a converter bridge arm module of a self-commutated pulse-control converter on the generator side of a voltage intermediate-circuit converter as shown in FIG. 2,

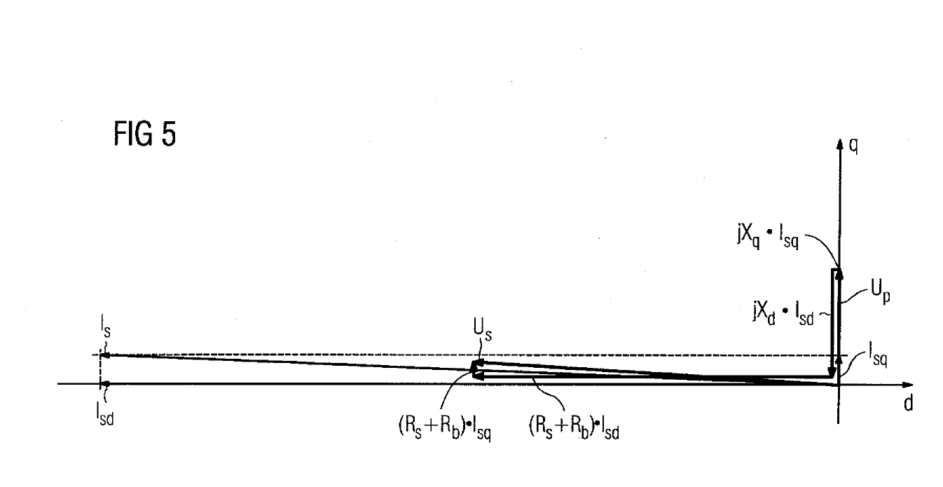

FIG. 5 shows a vector diagram of a virtually short-circuited synchronous generator with permanent magnet excitation in the braking mode, with the maximum braking power with the diesel engine at idling speed,

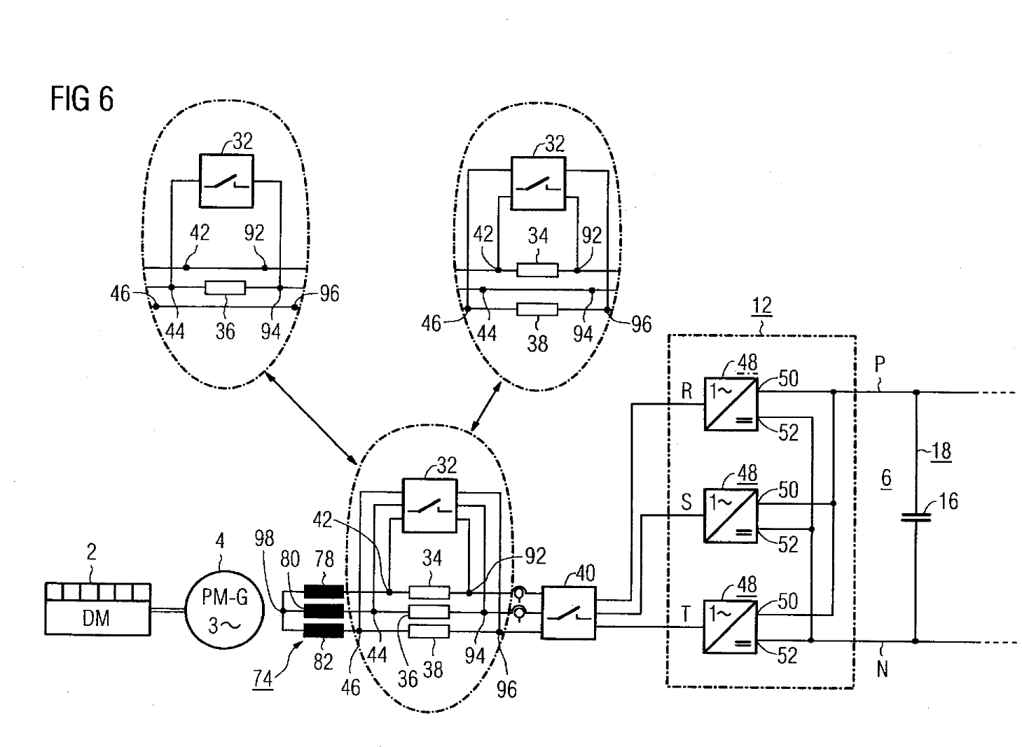

FIG. 6 shows an equivalent circuit of a second embodiment with variants of a diesel-electric drive system according to the invention, and

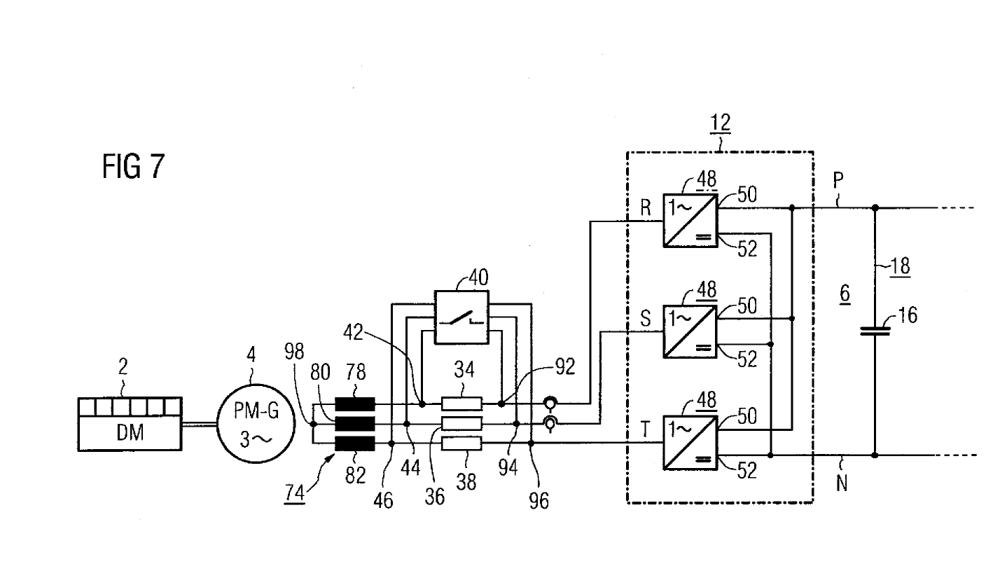

FIG. 7 shows an equivalent circuit of a third embodiment of a diesel-electric drive system according to the invention.

FIG. 1 shows an equivalent circuit of a diesel-electric drive system of this generic type, in which 2 denotes a diesel engine, 4 a synchronous generator with permanent magnet excitation, 6 a voltage intermediate-circuit converter, 8 a plurality of rotating field machines, in particular three-phase asynchronous motors, and 10 denotes a brake chopper. The voltage intermediate-circuit converter has a generator-side and a load-side self-commutated pulse-control converter 12 and 14, which are electrically conductively connected to one another on the DC voltage side by means of an intermediate circuit 18 which has an intermediate-circuit capacitor bank 16. The brake chopper 10 is connected electrically in parallel with this intermediate circuit 18 and has a braking resistance 20 and a braking controller 22, for example a gate turn off thyristor, which are connected electrically in series. This equivalent circuit also illustrates a capacitor bank 24, in particular composed of supercaps, a DC/DC converter 26 and an auxiliary inverter 28. On the input side, this DC/DC converter 26 is connected to the capacitor bank 24, and on the output side it is connected to the connections on the DC voltage side of the auxiliary inverter 28. In addition, the DC/DC converter 26 is connected electrically on the output side to the intermediate circuit 18 of the voltage intermediate-circuit converter 6. Auxiliary drives are connected to the connections on the AC voltage side of the auxiliary inverter 28, although these are not illustrated explicitly here. The diesel engine 2 and the synchronous generator 4 with permanent magnet excitation are mechanically coupled to one another on the rotor side, with the stator side of this synchronous generator 4 with permanent magnet excitation being linked to connections on the AC voltage side of the self-commutated pulse-control converter 12 on the generator side of the voltage intermediate-circuit converter 6.

Since this equivalent circuit is an equivalent circuit of a diesel-electric shunting locomotive, 30 denotes a traction container which accommodates the converter electronics. The braking resistance and the diesel-powered synchronous generator 4 with permanent magnet excitation are arranged outside this traction container 30. The four three-phase asynchronous motors 8 are the motors of the two bogies of a diesel-electric shunting locomotive.

The braking resistance 20, which is in the form of one resistor in this equivalent circuit, may also be formed from series-connected resistors. The gate turn off thyristor 22 is a converter bridge arm module in this embodiment, in which only the associated freewheeling diode is used instead of a second gate turn off thyristor. This converter bridge arm module also includes a circuitry network for the gate turn off thyristor and a so-called gate unit.

FIG. 2 schematically illustrates an equivalent circuit of a first embodiment of a diesel-electric drive system according to the invention. For the sake of clarity, the self-commutated pulse-control converter 14 on the load side of the voltage intermediate-circuit converter 6 and the three-phase asynchronous motors 8, as shown in FIG. 1, are no longer illustrated. The connections R, S and T on the AC voltage side of the self-commutated pulse-control converter 12 on the generator side of the voltage intermediate-circuit converter 6 are each connected to a respective connection 42, 44 and 46 on the stator side of the synchronous generator 4 with permanent magnet excitation such that they can be disconnected by means of a circuit breaker 40. This illustration also shows the windings 78, 80 and 82 of the polyphase stator winding system 74 of this synchronous generator 4 with permanent magnet excitation. These windings 78, 80 and 82 are respectively electrically conductively connected on the one hand to the connection 42, 44 and 46 on the stator side, and on the other hand to one of three braking resistances 34, 36 and 38. The braking resistances 34, 36 and 38 of the polyphase braking resistance arrangement are connected electrically in star in this illustration, and their values correspond to those of the braking resistance 20 of the embodiment shown in FIG. 1. These braking resistances 34, 36 and 38 in the polyphase braking resistance arrangement may also be connected electrically in delta (FIG. 3). In addition, a respective connection point 86 and 88 can be electrically conductively connected to a connection point 84 by means of a switching apparatus 32. The connection point of the switching apparatus 32 which is electrically conductively connected to the connection point 84 forms a star point 90 located outside the synchronous generator 4 with permanent magnet excitation. During the generator mode, this star point 90 is represented by this polyphase switching apparatus 32 which, for example, is a two-pole disconnector which is disconnected when the self-commutated converter 12 on the generator side of the voltage intermediate-circuit converter 6 is blocked. This can also occur at the rated rotation speed of the diesel-electric generator since the synchronous generator 4 with permanent magnet excitation is operated with inadequate excitation, and the synchronous generator 4 with permanent magnet excitation cannot feed into the intermediate circuit 18 via the freewheeling diodes in the blocked self-commutated pulse-control converter 12 on the generator side of the voltage intermediate-circuit converter 6, even at full rotation speed. In this mode with inadequate excitation, the rotor voltage of this synchronous generator 4 with permanent magnet excitation is too low for this purpose. It is therefore possible to make a transition to the braking mode very quickly from the maximum diesel-generator power at the rated rotation speed of the diesel engine 2, without the diesel engine 2 having to idle. As a result of the disconnection of the external star point 90 of the synchronous generator 4 with permanent magnet excitation, virtually the entire input voltage of the self-commutated pulse-control converter 12 on the generator side is applied to the resistance terminals (connection points 84, 86 and 88) when the synchronous generator 4 with permanent magnet excitation is short-circuited. In order to allow these braking resistances 34, 36 and 38 in the polyphase braking resistance arrangement to be connected electrically in series with a respective winding 78, 80 and 82 in the polyphase stator winding system 74 of the synchronous generator 4 with permanent magnet excitation, the winding ends (connection points 84, 86, 88 and stator-side connections 42, 44, 46) of these windings 78, 80 and 82 must be passed out of the synchronous generator 4 with permanent magnet excitation. A star point 90, which is located outside the synchronous generator 4 with permanent magnet excitation, for the stator winding system 74 can then be switched by means of the polyphase switching apparatus 32, for normal operation.

This switchable series connection, according to the invention, of three braking resistances 34, 36 and 38 in the polyphase braking resistance arrangement to the windings 78, 80 and 82 of the polyphase stator winding system 74 in the synchronous generator 4 with permanent magnet excitation, by means of a voltage intermediate-circuit converter, makes it possible to use a two-pole disconnector 32 through which no current flows to switch between the generator mode and the braking mode, thus allowing a high braking power to be achieved and the rotation of the diesel engine to be set freely in the braking mode.

The self-commutated pulse-control converter 12 on the generator side of the voltage intermediate-circuit converter 6 in this embodiment of the diesel-electric drive system is provided by means of converter bridge arm modules 48. FIG. 4 shows an equivalent circuit of a converter bridge arm module 48 in more detail. The connections 50 and 52 on the DC voltage side of each converter bridge arm module 48 in the self-commutated pulse-control converter 12 on the generator side are each electrically conductively connected to a potential in the intermediate circuit 18 of the voltage intermediate-circuit converter 6. In this case, the connections 50 on the DC voltage side of the three converter bridge arm modules 48 in the self-commutated pulse-control converter 12 are each connected to a positive potential P in the intermediate circuit 18 while, in contrast, the connections 52 on the DC voltage side of these three converter bridge arm modules 48 are each linked to a negative potential N in the intermediate circuit 18.

According to this equivalent circuit as shown in FIG. 4, the converter bridge arm module 48 has two bridge arm modules 54 which are connected electrically in parallel. Each bridge arm module 54 has two semiconductor switches 56 and 58 which can be turned off and are connected electrically in series, in particular two insulated gate bipolar transistors (IGBTs) which are respectively provided with a corresponding freewheeling diode 60 and 62. For traction purposes, traction converters are designed to be as modular as possible, with a bridge arm module 54 being used as the smallest unit. In the illustration shown in FIG. 3, the parallel connection of two bridge arm modules 54 results in a high-power converter bridge arm module 48.

FIG. 5 uses an orthogonal coordinate system d, q to illustrate a vector diagram relating to the braking mode with full braking power. In the braking mode, the three braking resistances 34, 36 and 38 in the polyphase braking resistance arrangement are respectively connected electrically in series with a winding 78, 80 and 82 in the polyphase stator winding system 74 of the synchronous generator 4 with permanent magnet excitation. In consequence, the synchronous generator 4 with permanent magnet excitation is operated virtually short-circuited, with the continuous short-circuit current I_{sd} not exceeding, or only slightly exceeding, the rated current provided that the series inductance L_{d} is adequate. This continuous short-circuit current I_{sd} flows through the series-connected braking resistances 34, 36 and 38, thus dissipating the required braking power. The virtually entirely short-circuited synchronous generator 4 with permanent magnet excitation results in the voltage Uₛ at the connections R, S and T on the AC voltage side of the self-commutated pulse-control converter 12 on the generator side of the voltage intermediate-circuit converter 6 being applied virtually completely to the terminals (connection points 84, 86, 88) of the braking resistances 34, 36 and 38, in order to drive a braking current Iₛ. Since the continuous short-circuit current I_{sd} of the synchronous generator 4 with permanent magnet excitation is approximately constant between idling, for example 600-700 rpm, and a rated rotation speed of, for example, 1800-1900 rpm of the diesel-electric engine 2, the rotation speed of the diesel engine 2 may be chosen freely in the braking mode. The iron losses in the braking mode in the synchronous generator with permanent magnet excitation are very low, because of the field-attenuating short-circuit current I_{sd}. The drag losses, which correspond to the rotation speed of the diesel engine 2, of the synchronous generator 4 with permanent magnet excitation can be compensated for by a small positive q-current component (torque-forming current I_{sq}). The diesel engine 2 can therefore run without fuel injection while the diesel-electric drive system is in the braking mode.

FIG. 6 schematically illustrates a second embodiment of the diesel-electric drive system according to the invention. This embodiment differs from the embodiment shown in FIG. 2 in that the braking resistances 34, 36 and 38 in the polyphase braking resistance arrangement are now connected to the connections 42, 44 and 46 on the stator side of the synchronous generator 4 with permanent magnet excitation. A second connection of a braking resistance 34, 36 and 38 therefore in each case forms a respective connection 92, 94 and 96 on the AC voltage side of the synchronous generator 4 with permanent magnet excitation, to which the connections R, S and T on the AC voltage side of the self-commutated pulse-control converter 12 on the generator side of the voltage intermediate-circuit converter 6 are connected by means of the polyphase circuit breaker 40. The windings 78, 80 and 82 of the polyphase stator winding system 74 of the synchronous generator 4 with permanent magnet excitation are connected electrically in star in this embodiment, by means. of an internal star point 98. The braking resistances 34, 36 and 38 in the polyphase braking resistance arrangement can each be electrically bridged by means of a polyphase switching apparatus 32. This means that these braking resistances 34, 36 and 38 are electrically short-circuited when the diesel-electric drive system is not in the braking mode.

Instead of three braking resistances 34, 36 and 38, it is also possible to provide only two braking resistances 34 and 38 or else only one braking resistance 36, which can likewise be connected electrically in series with two or with one winding 78 and 82 or 80, respectively, in the polyphase stator winding system 74 by means of the switching apparatus 2. Details relating to these two options are likewise shown in this illustration in FIG. 6. The switching apparatus 32 has a three-pole, two-pole or single-pole disconnector, corresponding to the number of braking resistances 34, 36 and 38 used in the polyphase braking resistance arrangement. The braking resistance or resistances 34 and 38 or 36 must be designed appropriately for the required braking power and as a function of a current I_{sd} flowing in the synchronous generator 4 with permanent magnet excitation. The advantage of this embodiment as illustrated in FIG. 6 is that there is no longer any need to pass all the winding ends of the windings 78, 80 and 82 of the polyphase stator winding system 74 out of the synchronous generator 4 with permanent magnet excitation. It is therefore possible to use any commercially available synchronous machine with permanent magnet excitation.

FIG. 7 illustrates a third embodiment of the diesel-electric drive system according to the invention. This embodiment differs from the embodiment shown in FIG. 6 in that the polyphase circuit breaker 40 is now used instead of the polyphase switching apparatus 32. This circuit breaker 40 therefore carries out two tasks, specifically protection of the self-commutated pulse-control converter 12 on the generator side of the voltage intermediate-circuit converter 6 during normal operation and in the braking mode, as well as the function of three-phase short-circuiting of the braking resistances 34, 36 and 38. There is no difference in the method of operation of these three embodiments of the diesel-electric drive system according to the invention as shown in FIGS. 2, 6 and 7.

1.-8. (canceled)

9. A diesel-electric drive system comprising:
a permanent-magnet-excited synchronous generator with a rotor and a stator comprising a polyphase stator winding system, wherein the rotor is mechanically coupled to a diesel engine and the stator is connected to a voltage intermediate-circuit converter, said voltage intermediate-circuit converter comprising a self-commutated pulse-controlled converter on the generator side and on the load side, with the generator side and the load side being linked by a DC voltage intermediate circuit,
a polyphase braking resistance arrangement comprising a plurality of braking resistors, and
a polyphase switching device for electrically connecting the braking resistors of the polyphase braking resistance arrangement in series with the polyphase stator winding system.

10. The diesel-electric drive system of claim 9, wherein windings of the polyphase stator winding system and braking resistors of the polyphase braking resistance arrangement are electrically connected in series in one-to-one correspondence at junction points, and wherein the polyphase switching device comprises two disconnect switches with corresponding terminals, wherein first terminals of the disconnect switches are connected to each other and to a first of the junction points, and second terminals of the two disconnect switches are each connected to corresponding second and third junction points in one-to-one correspondence.

11. The diesel-electric drive system of claim 9, wherein windings of the polyphase stator winding system and braking resistors of the polyphase braking resistance arrangement are electrically connected in series in one-to-one correspondence at junction points, and wherein the polyphase switching device comprises three short-circuit devices, with each short-circuit device being connected electrically in parallel with a braking resistor in one-to-one correspondence.

12. The diesel-electric drive system of claim 9, wherein two of the windings of the polyphase stator winding system and two corresponding braking resistors of the polyphase braking resistance arrangement are electrically connected in series in one-to-one correspondence at two junction points, and wherein the polyphase switching device comprises two short-circuit devices, with each of the two short-circuit devices being connected electrically in parallel with a corresponding one of the two braking resistors in one-to-one correspondence.

13. The diesel-electric drive system of claim 9, wherein one of the windings of the polyphase stator winding system and a corresponding braking resistor of the polyphase braking resistance arrangement are electrically connected in series in one-to-one correspondence at a junction point, and wherein the polyphase switching device comprises one short-circuit device which is connected electrically in parallel with the corresponding braking resistor.

14. The diesel-electric drive system of claim 9, wherein windings of the polyphase stator winding system and braking resistors of the polyphase braking resistance arrangement are electrically connected in series in one-to-one correspondence, and wherein a polyphase circuit breaker is connected electrically in parallel with the braking resistors.

15. The diesel-electric drive system of claim 10, wherein the braking resistors in the polyphase braking resistance arrangement are electrically connected in a star configuration.

16. The diesel-electric drive system of claim 10, wherein the braking resistors in the polyphase braking resistance arrangement are electrically connected in series.
